(19) United States
(12) Patent Application Publication
(10) Pub. No.: US 2010/0201352 A1
(43) Pub. Date: Aug. 12, 2010

(54) System and method for detecting ball possession by means of passive field generation

(75) Inventor: Walter ENGLERT, Burgrieden (DE)

Correspondence Address: GLENN PATENT GROUP, 3475 EDISON WAY, SUITE L, MENLO PARK, CA, 94025, US

(73) Assignee: Cairos Technologies AG, Karlsbad (DE)

(21) Appl. No.: 12/638,793

(22) Filed: Dec. 15, 2009

Related U.S. Application Data
(60) Provisional application No. 61/122,536, filed on Dec. 15, 2008.

(30) Foreign Application Priority Data
Dec. 15, 2008 (DE) 102008062276.1

(51) Int. Cl. G01B 7/14

(52) U.S. Cl. 324/207.22

(57) ABSTRACT

System for ball possession detection, which contains a device (130) comprising means for detecting a magnetic field in a playing device (100) of a ball game, wherein the magnetic field is generated by at least one permanent magnetic (110) in the playing device, wherein the device can be associated to a player of a ball game and the means for magnetic field detection comprise a magnetic field sensor (210) and a control unit (220), and a method for ball possession detection, wherein the magnetic field sensor detects a magnetic field (310), the control means measures the magnetic field strength of the detected magnetic field (320) and detects (330) whether the magnetic field was caused by the at least one permanent magnet in the playing device and outputs information about the detection (350), as well as a ball (100) that contains at least one permanent magnet.

The present invention generally refers to the detection and provision of player-related information in ball games and especially to the detection and provision of information with respect to the ball possession of a player.

In ball games, such as soccer, there is an increasing interest in studying interaction of participating persons with the playing device as well as further characteristics. An objective evaluation of this information is in the interest of the persons participating in the game and of the spectators.

In a soccer game it is amongst others interesting to know how often and how long a team or an individual player was in ball possession. This requires a technical device to determine whether the ball moves within a certain radius around a player. However, it is generally not desired to adversely affect the course of the game by possibly interfering technical measures.

In existing systems it was attempted to obtain this information by means of field strength measurement of a radio transmitter inside the ball. However, radio waves have the disadvantage that the reach can be measured very imprecisely only due to reflections and antenna characteristics. Thus, a clear ball possession detection is hardly possible if for instance several players of adverse teams fight for the ball within a small area.

The present invention finds a remedy for that. The present invention is based on the knowledge that it is possible and advantageous to generate a magnetic field in the playing device, e.g. the ball, by one or several permanent magnets. The player itself must therefore carry only a small device, preferably accommodated in the shoe or shin guard of the player. This device contains a magnetic field sensor for detecting the magnetic field of one or several permanent magnets.

The signals of the magnetic field sensor are evaluated by a control unit to detect whether the device and thus the foot of the player is in direct proximity to the ball. If the control signal detects such a ball possession event, this information is output together with a time stamp. The information can also be stored, wherein the storage process is either repeated continuously as long as the magnetic field of the permanent magnet is detected or the event is stored with a starting and an end time stamp.

As an alternative, the control unit can transfer via a respective radio module the detection of the magnetic field of the permanent magnet to a central detection unit.

As an alternative, the control unit can transfer via a respective radio module the detection of the magnetic field of the permanent magnet to a central detection unit. Thus, a prompt evaluation of the ball possession of all players is possible. This inures to the benefit of the spectators who can access such information and statistics also during the game while when this information is being stored, this is only possible during breaks or after the end of the game.

Preferred embodiments of the present invention will be explained closer with reference to the enclosed drawings.

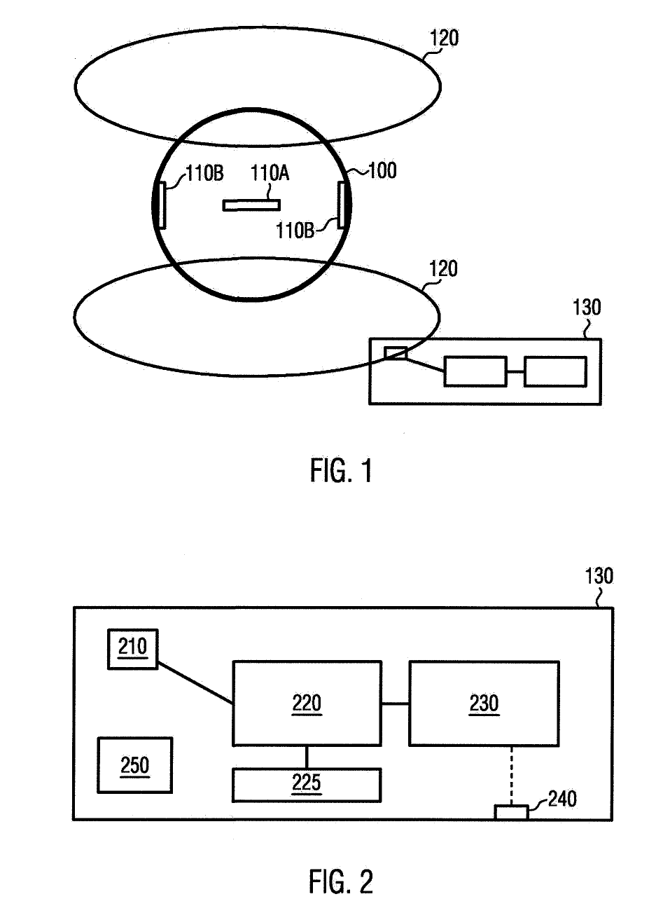

FIG. 1 shows a schematic view of a system according to an embodiment of the present invention;

FIG. 2 shows a schematic view of a player-sided device according to an embodiment of the present invention;

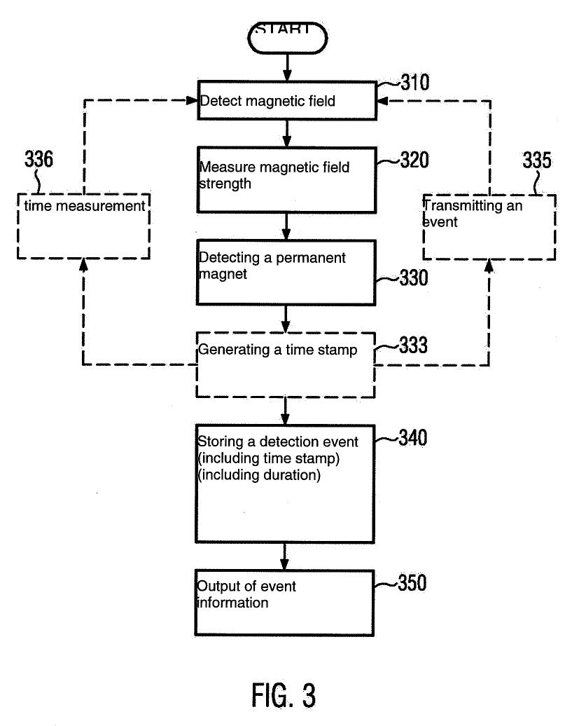

FIG. 3 is a flow chart to explain the method of detecting ball possession information according to an embodiment of the present invention;

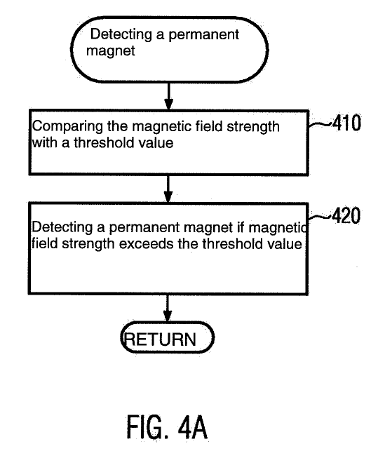

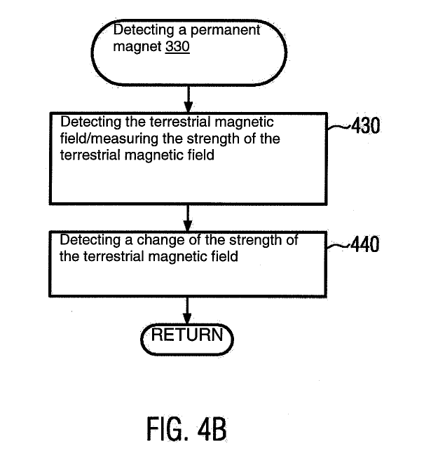

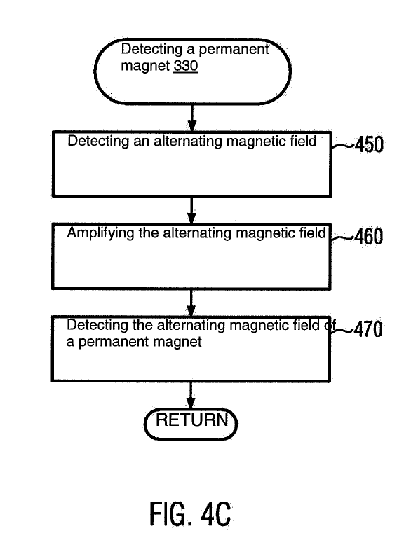

FIG. 4A shows a method of detecting a permanent magnet according to an embodiment of the present invention;

FIG. 4B shows a method of detecting a permanent magnet according to a different embodiment of the present invention; and

FIG. 4C shows a method of detecting a permanent magnet according to a further embodiment of the present invention.

To clarify the invention, the enclosed drawings are explained in detail. The following description of the drawings starts out from embodiments of the invention, however, the present invention is not limited to the individual embodiments. The present invention is particularly explained in detail for the soccer game, however, the application thereof is not limited to this special type of ball game.

FIG. 1 shows a schematic view of a system and a device for detecting a magnetic field and a ball according to an embodiment of the present invention. The system comprises the ball 100 equipped with at least one permanent magnet. FIG. 1 shows a first permanent magnet 110A preferably attached in the center of the ball. This can be managed by a fixation by means of threads or springs. In a different embodiment the permanent magnet 110A is held at its central position by means of a soft foam filling the interior of the ball.

In an alternative embodiment, two or more permanent magnets are integrated in or attached to the ball wall. This can for instance be managed during manufacture of an inner shell or inner sleeve of the ball. The present invention is neither limited to these attachment methods nor to the described or shown number of permanent magnets.

The permanent magnets in the ball serve for generating a magnetic field with a preferably predetermined reach. The selected reach can for instance be determined by the size or the material of the permanent magnet. By this, both the determination of a direct ball possession, i.e. a contact between the soccer shoe and the ball can be managed, as well as a determination by several soccer shoes in the proximity of the ball to allow conclusions on the so-called ball possession of individual players. By the reach of the permanent magnets, devices of several players, who for instance try to get possession of the ball, can detect the distance to the ball.

Furthermore, the use of permanent magnets is particularly cost-effective for the entire system. Such a ball does for instance not need an independent power supply, as it is the case in magnetic field generators. Furthermore, a permanent magnet can be attached in a more favorable and simpler manner in the ball than solutions comprising electronic circuits.

FIG. 1 furthermore shows a device 130 for detecting the ball possession or the proximity to a ball. The device 130 is shown in FIG. 1 in a manner that it is in the direct sphere of influence of the magnetic field 120 of one of the permanent magnets. By the increase of the magnetic field strength with the approach of the device 130 to the ball 100, the device 130 can determine a ball possession. The device 130 can for instance, as will be explained further below, compare the measured magnetic field strength with a threshold value and when exceeding the threshold value it can detect a permanent magnet or ball possession. According to an embodiment, this threshold value can be set depending on the strength of the permanent magnet in a manner that a range of up to 25 cm around the ball is interpreted as ball possession.

FIG. 2 shows the above-mentioned device 130 in more detail. It contains the magnetic field sensor 210 that generates a sensor signal depending on the measured magnetic field strength. In a further embodiment, the device 130 can also be equipped with two or more magnetic field sensors. In an embodiment of the present invention, the magnetic field sensor 122 preferably contains a magneto-resistive element or a Hall element. If the magnetic field strength is measured by magnetic-resistive sensors as magnetic field-dependent resistances, they can be switched to form a bridge. The output signal of the bridge can be amplified by a differential amplifier. The output voltage is a direct measure for the field strength of the measured magnetic field. In order to obtain an analyzable signal upon each possible axis of rotation of the ball, two or more sensors offset by 90 degrees can be used.

As an alternative, the field strength can be measured by Hall sensors. Hall sensors generate a voltage proportional to the field strength. This voltage can be amplified by the aid of a differential amplifier. The output voltage is a direct measure for the field strength of the magnetic field. The evaluation of this voltage can either be implemented discretely through an analog circuit or by the aid of a control unit 220, e.g. a microcontroller. In order to obtain an analyzable signal upon each possible axis of rotation of the ball, two or three sensors offset by 90° can be used.

The control unit 220, which is coupled to the magnetic field sensor to detect an output signal, further processes the signal. In an embodiment of the present invention, the control unit 220 compares the received signal of the magnetic field sensor 210 with a threshold value to determine whether a permanent magnet is in the direct proximity to the magnetic field sensor 210. These and further embodiments are explained in detail further below with respect to FIGS. 3 and 4.

In an embodiment of the present invention, the device 130 can also contain a memory unit 225. This memory 225 enables the control unit 220 to store events, such as the exceeding of a threshold value by the magnetic field sensor signal.

FIG. 2 also shows an output module 230, which enables the output of the detected events. In an embodiment of the present invention, the output unit 230 is provided by a transmission unit. The transmission unit is adapted such that it can transmit data to a central detection unit. This central detection unit can for instance be arranged at the sideline or at a different location from which the signals of transmission units can be received on the entire field. Thus, a transmission of information generated by the control unit is possible any time during the game.

As an alternative, events that are detected by the control unit 220, are stored but they are transmitted by means of a transmission unit 230 to the central detection unit upon termination of the game or during a brake. Thus, the transmission power of the transmission unit can be reduced.

In a further embodiment, the output module 230 is formed by a wire-bound interface. This interface is for instance coupled with a plug connection 240, wherein the connection of a central detection unit is enabled by a cable. By connecting the device 130 to the central detection unit, the content of the memory can be read out, whereby the entire course can be determined in view of the ball possession or proximity of a player to the ball.

The device 130 further contains an energy source 250. The energy source 250 is a battery according to an embodiment of the present invention. The device 130 is for instance supplied by a lithium battery. The capacitance of the battery is adapted such that the functionality of the electronics in the device 130 is ensured over a determined number of several hundreds or thousands of operating hours. The energy source 250 can preferably be provided as an exchangeable unit that can be exchanged by the user without great effort.

FIG. 3 shows a flow chart to explain a method for detecting a ball possession or a direct proximity between soccer shoe and ball 100.

The system 130 is preferably attached to a garment of a player. The system 130 can for instance be integrated in a soccer shoe or it can be attached to a shin protector. If the player, and thus the system 130, approaches the ball, the magnetic field sensor 210 can detect a magnetic field, step 310. A detection signal is forwarded from the sensor 210 to the control unit 220. By the detection of the magnetic field, the control unit 220 measures in step 320 the magnetic field strength that can be tapped in the form of sensor signals of the magnetic field sensor 210. The device 130 has therefore reached the sphere of influence of the permanent magnet in the ball. For instance a player has approached the ball and tries to possess the ball.

Furthermore, the control unit 220 detects in step 330 the permanent magnet or the magnetic field of the permanent magnet. The methods of FIGS. 4A to 4C show three embodiments of step 330. These three methods can also be used to detect how close the player has come to the ball.

In an embodiment of the present invention, the control device 220 stores in step 340 information concerning the above-mentioned event of ball approach. This information can for instance comprise magnetic field strength of the permanent magnet in the ball.

In a further embodiment of the present invention, a time stamp can be generated in step 333, if the control unit 220 detects a permanent magnet. This time stamp can be stored together with the information concerning a detection event. If information concerning the ball possession is provided with such a time stamp, it can for instance be evaluated if a ball was successfully passed. It can for instance be determined in an evaluation that the next event was activated by a different player that belongs to the same team as the player that activated the first event. Thus, the ball was successfully passed within a team.

In the same way, the results of two systems 130 can be evaluated in that a player of the adversary team reaches ball possession. For this purpose the time stamp generated in step 333 can be stored together with the event in step 340.

In a different embodiment the event is not yet stored but it is proceeded with the detection of the magnetic field and the measurement of the magnetic field strength. As shown in FIG. 3, an optional time measurement 336 exists that measures the duration of an event. In other words, as long as a permanent magnet is detected in step 330, it is proceeded with the time measurement until a change at step 330 is detected. Subsequently, the event can be stored together with the duration. The information with respect to the event is for instance provided with a start time and an end time and is subsequently stored.

As mentioned above, several embodiments exist concerning the transfer of information to a central evaluation unit with respect to a ball possession event. In a first embodiment the data stored is output in step 350 to the central evaluation unit. This output can for instance be transmitted via a transmission unit to a respective receiver coupled with the evaluation unit. This for instance enables that a player during a break or after termination of the game brings its shoe in the proximity of the receiver, which can activate the transmission of the transmission unit.

In a further embodiment, the transmission is implemented by means of a cable, for which the device 130 is connected via the interface 240 and a cable to the central evaluation unit. This embodiment enables a more energy-saving and thus also smaller embodiment as if the device 130 would contain an independent transmission unit.

In another embodiment the events are not stored but are transmitted immediately after generating the time stamp in step 333 to the central evaluation unit, step 335. This embodiment enables a more simple design, since the system 130 does not require a memory 225. In any case, the detection of the magnetic field re-starts in step 310 as soon as the data is transmitted in step 335 or output in step 350.

Referring to FIGS. 4A to 4C different embodiments will now be explained how the proximity of a permanent magnet can be detected.

FIG. 4A shows a method of detecting a permanent magnet if this magnet is located in direct proximity to the device 130. This method is for instance suitable for the detection of the ball possession, since by suitable parameters distances up to 25 cm between the ball and the soccer shoe can be detected. In a first step 410 the magnetic field strength is compared to a threshold value. The magnetic field strength was, as shown in FIG. 3, measured in step 320 by the aid of the magnetic field sensor 210. Depending on the permanent magnet used the threshold value can for instance be pre-adjusted such that an exceeding of the threshold value corresponds to a distance to the ball of less than 25 cm. In a further step 420 a permanent magnet is detected in that the measured magnetic field strength exceeds the threshold value. This information is processed by the control unit 220. A predetermined identification number can for instance be associated to this event, which is either directly transmitted to a central detection unit or which is stored in the memory 225.

According to the method of FIG. 4b, the detection of a permanent magnet is determined in consideration of the terrestrial magnetic field. In step 430 the terrestrial magnetic field is detected and the strength of the terrestrial magnetic field is measured. This step can for instance be implemented if a player enters the field. Usually, the terrestrial magnetic field is equally strong on the entire field. The device 130 can for instance also be equipped with an input key, whereby a player can activate the detection of the terrestrial magnetic field. In any case it is required that the player is not in the proximity of a ball equipped with a permanent magnet.

In step 440 it is detected whether the strength of the terrestrial magnetic field has changed. Since natural causes for this are excluded, such a change must have been caused by a magnet. The control unit 220 can therefore detect by comparison of the magnetic field strength measured in step 320 with the terrestrial magnetic field strength whether the player is located in the proximity of the ball, but is not so close to the ball, as described with reference to FIG. 4A.

The method of FIG. 4B is for instance suitable for distance measurements of up to 50 cm from the ball. This distinction between the detection of a permanent magnet in the direct range (see FIG. 4A) and a somewhat greater range (see FIG. 4B) is for instance suitable for evaluating a ball transfer between two players of opposing teams. In such situations of a game it frequently occurs that several players are in direct proximity to the ball. Which soccer shoe was at the ball at which moment can therefore advantageously be evaluated.

According to a further embodiment of the present invention, the proximity to a permanent magnet can also be detected as follows. In step 450 the control unit 220 determines that the magnetic field sensor 210 has detected an alternating magnetic field. For this purpose, at least one capacitor can for instance be provided in the magnetic field sensor 210. Thus, it is possible that the measuring outputs of the magnetic field sensor are decoupled through the at least one capacitor in a manner that only alternating fields are passed through to the amplifiers. Caused by the enlarged amplification factor, weaker alternating fields can also be detected. Subsequently, the alternating magnetic field is amplified, step 460, to enable an evaluation.

The control device 220 now determines in step 470 that the alternating magnetic field of a permanent magnet is located in the closer proximity. Since in most ball games the ball moves in a rolling or rotating manner, the ball 100 equipped with the permanent magnets 110, always outputs an alternating magnetic field. This alternating magnetic field can well be detected due to the amplification. The method according to FIG. 4C is for instance suitable for distances between the player and a ball of up to one meter. As mentioned above, such events can advantageously be used to detect whether an approaching player has successfully taken the ball from an opposing player. Such an event can be provided with a respective identification number by the control unit 220. Thus, the evaluation of the information is more simple, if depending on the method of FIGS. 4A to 4C different identification numbers are used.

According to the present invention, it is possible by an evaluation of the ball possession information to obtain detailed information about the players participating in the game. This allows an analysis of the individual players by the evaluation of the total times during which a player was in ball possession. This data is interesting for hobby players but also for trainers of professional players.

1. Device (130) for the detection of a ball possession by means for detecting a magnetic field in a playing device (100) of a ball game, wherein the magnetic field is generated by at least one permanent magnet (110) in the playing device, wherein the device can be associated to a player of a ball game and the means for magnetic field detection comprise:
a magnetic field sensor (210); and
a control unit (220) coupled to the magnetic field sensor to receive a sensor signal from the magnetic field sensor, and which is adapted to detect whether the sensor signal was caused by the magnetic field of the at least one permanent magnet in the playing device, and for outputting information about the detection.

2. Device as claimed in claim 1, wherein the magnetic field sensor detects the magnetic field of the at least one permanent magnet and measures the strength of the magnetic field.

3. Device as claimed in claim 2, wherein the magnetic field sensor furthermore detects the terrestrial magnetic field and measures the terrestrial magnetic field strength, and wherein the control unit detects the magnetic field of the at least one permanent magnet due to a change of the terrestrial magnetic field strength by the at least one permanent magnet.

4. Device as claimed in claim 2, wherein the magnetic field sensor is adapted to detect an alternating magnetic field generated by rotation of the at least one permanent magnet in the playing device, and wherein the control unit is adapted to output information about the detection of the alternating magnetic field.

5. Device as claimed in claim 4, wherein the magnetic field sensor comprises at least one measuring output terminal, and wherein the at least one measuring output terminal is de-coupled through at least one capacitor.

6. Device as claimed in at least one of claims 1 to 5, wherein the magnetic field sensor comprises at least one amplifier.

7. Device as claimed in one of claims 1 to 6, wherein the control unit is adapted to output the detection of the magnetic field together with a time stamp that is associated to the time of detection.

8. Device according to one of claims 1 to 7, wherein the means for magnetic field detection further comprise:
a memory unit (225);
wherein the control unit is further adapted to store the output information in the memory unit.

9. Device according to claim 8, wherein the device comprises an output unit (230) which enables a read out of the memory unit.

10. Device according to one of claims 1 to 7, wherein the means for magnetic field detection further comprise:
a transmission unit;
wherein the control unit is further adapted to transfer the output information by means of the transmission unit to a central evaluation unit.

11. Device according to claim 9, wherein the device is arranged in or on a garment of the player that is preferably located in the proximity of the ball when playing the ball game.

12. Method for ball possession detection by detecting a magnetic field in a playing device (100) of a ball game, wherein the magnetic field is generated by at least one permanent magnet (110) in the playing device, and wherein the method comprises:
detecting (310) a magnetic field;
measuring (320) the magnetic field strength of the detected magnetic field;
detecting (330) whether the magnetic field was caused by the at least one permanent magnet in the playing device; and
outputting (350) information about the detection.

13. Method as claimed in claim 12, wherein the detection comprises the detection of the magnetic field of the at least one permanent magnet, and measuring comprises measuring the associated magnetic field strength, and wherein detection comprises comparing (410) the measured magnetic field strength with a threshold value.

14. Method as claimed in claim 12, wherein the detection comprises the detection (430) of the terrestrial magnetic field, and measuring comprises the measuring (430) of the terrestrial magnetic field strength, and wherein detection comprises the detection (440) of a change of the terrestrial magnetic field strength.

15. Method as claimed in claim 12, wherein detection comprises the detection (450) of an alternating magnetic field of the at least one permanent magnet in the playing device, and measuring comprises the measuring of the strength of the alternating magnetic field, and wherein detection comprises the detection (470) of the alternating magnetic field.

16. Method as claimed in one of claims 12 to 15 further comprising:
storing the output information.

17. Method as claimed in one of claims 12 to 16, further comprising:
transferring the output information to a central evaluation unit.

18. Ball containing at least one permanent magnet to carry out the method according to one of claims 12 to 17.
